(19) United States
(12) Patent Application Publication
(10) Pub. No.: US 2024/0251771 A1
(43) Pub. Date: Aug. 1, 2024

(54) FISHING REEL

(71) Applicant: GLOBERIDE, INC., Tokyo (JP)

(72) Inventor: Kazuya NAMBU, Higashikurume-shi (JP)

(73) Assignee: GLOBERIDE, INC., Tokyo (JP)

(21) Appl. No.: 18/386,650

(22) Filed: Nov. 3, 2023

(30) Foreign Application Priority Data
Feb. 1, 2023 (JP) 2023-013716

(51) Int. Cl. A01K 89/015

(52) U.S. Cl. CPC A01K 89/01931

(57) ABSTRACT

A fishing reel according to the present invention comprises a level wind device that uniformly winds a fishing line around a spool rotatably supported between left and right side plates of a reel body. The level wind device comprises a fishing line guide that comprises: a pair of rollers each provided with a through hole extending in an axial direction; a pair of roller fixing shafts inserted into the through holes of the pair of rollers and rotatably supporting the rollers; and a base portion supporting the pair of roller fixing shafts and engaging with a worm shaft supported between the left and right side plates, and a fishing line is inserted into between the pair of rollers.

### CROSS-REFERENCE TO RELATED APPLICATION

This application claims priority under 35 U.S.C. § 119 to Japanese Patent Application No. 2023-013716 filed on Feb. 1, 2023 in the Japanese Patent Office, the entire contents of each hereby incorporated by reference.

### BACKGROUND OF THE INVENTION

### 1. Technical Field

The present invention relates to a fishing reel comprising a level wind device, which winds and guides a fishing line around a spool, at a position between side plates and in front of the spool.

### 2. Description of the Related Art

Conventionally, in a double bearing type fishing reel, a level wind device is disposed so as to evenly wind a fishing line around a spool rotatably supported between left and right side plates. The level wind device includes a fishing line guide that reciprocates left and right in front of the spool in conjunction with a winding operation of a handle rotatably arranged on one side plate side, and the fishing line can be evenly wound around the spool by inserting the fishing line into the fishing line guide.

Since the above-described fishing line guide is a portion through which the fishing line is inserted while being brought into contact with the fishing line guide, when the frictional resistance is large, problems occur such as a decrease in the flying distance and rubbing of the fishing line at the time of casting a bait, and a decrease in the falling speed at the time of causing the bait to freely fall. In order to solve such problems, JP S56-131771 U discloses a level wind device including a fishing line guide where a pair of rollers through which to insert a fishing line is disposed in a base portion screwed to a worm shaft rotatably supported between left and right side plates.

The pair of rollers is rotatably supported so that their outer circumferential surfaces are exposed in a fishing line insertion portion, and each lower has a lower end side held by the base portion and an upper end side held by a receiving portion. The base portion is screwed to the worm shaft, and the receiving portion is held by a cover member engaged with a support column supported between the left and right side plates, so that the fishing line guide is reciprocated between the left and right side plates. The fishing line inserted between the pair of rollers can reduce frictional resistance by their outer circumferential surfaces.

### SUMMARY OF THE INVENTION

In the above-described conventional level wind device, since the pair of rollers constituting the fishing line guide are respectively covered with roller covers, the surface of each roller comes into contact with the roller cover, and therefore a sufficient friction reducing effect cannot be obtained. In addition, since each roller has a configuration such that the roller is held by the roller cover and has an upper end held by the hard receiving portion and integrally incorporated with the cover member, the number of components is increased and rattling is likely to occur. Furthermore, since the number of components is large, the device is not easy to incorporate and its cost increases.

The present invention has been made in view of the above problems, and an object of the present invention is to provide a fishing reel having a low cost level wind device that enables the frictional resistance of a pair of rollers arranged in a fishing line guide through which a fishing line is inserted to be reduced, has a simple structure, and is easy to incorporate.

In order to achieve the above object, the present invention provides a fishing reel comprising a level wind device that uniformly winds a fishing line around a spool rotatably supported between left and right side plates of a reel body, in which the level wind device comprises a fishing line guide that comprises: a pair of rollers each provided with a through hole extending in an axial direction; a pair of roller fixing shafts inserted into the through holes of the pair of rollers and rotatably supporting the rollers; and a base portion supporting the pair of roller fixing shafts and engaging with a worm shaft supported between the left and right side plates, and a fishing line is inserted into between the pair of rollers.

According to the fishing reel having the above-described configuration, since the roller fixing shafts are inserted respectively into the through holes of the pair of rollers constituting the fishing line guide through which the fishing line is inserted, it is possible to rotatably support the rollers with their surfaces exposed. Thus, the frictional resistance force against the fishing line inserted into between the rollers can be reduced. In addition, since the rollers are only held by the pair of roller fixing shafts, the number of components is reduced and the structure is simplified, thus enabling the reel to be easier to incorporate and made at low cost.

The present invention provides a fishing reel having a low cost level wind device that enables the frictional resistance of a pair of rollers arranged in a fishing line guide through which a fishing line is inserted to be reduced, has a simple structure, and is easy to incorporate.

### BRIEF DESCRIPTION OF THE DRAWINGS

FIG. 1 is a perspective view illustrating an embodiment of a fishing reel according to the present invention as viewed from a front side;

FIG. 2 is an exploded view illustrating a configuration of a fishing line guide of a level wind device; and

FIG. 3 is a cross-sectional view illustrating a configuration of the fishing line guide.

### DETAILED DESCRIPTION

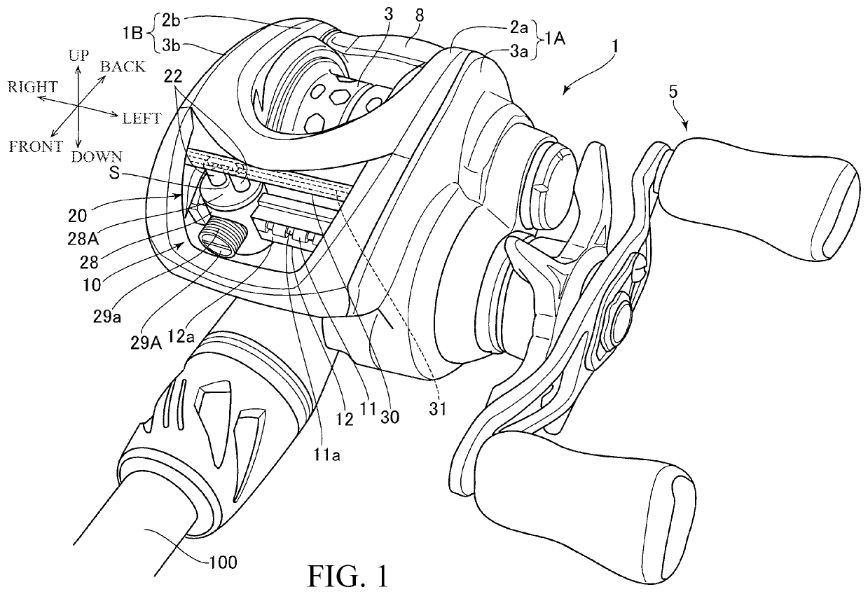

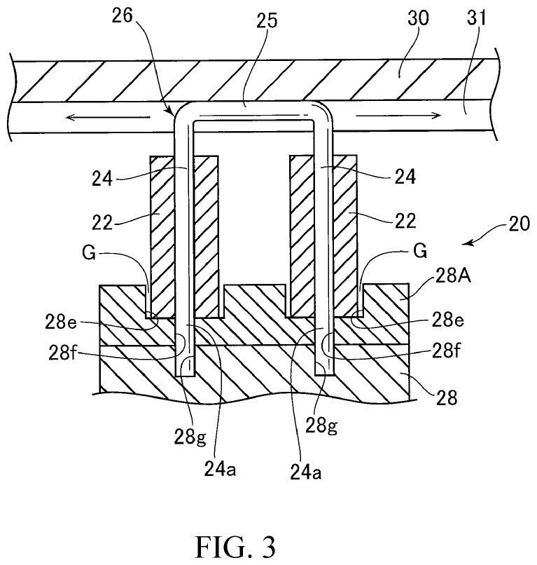

Hereinafter, a fishing reel according to the present invention will be described with reference to FIGS. 1 to 3. Note that, in the following description, the front-back direction (front side, back side), left-right direction, up-down direction (upper side, lower side) will be defined as directions illustrated in FIG. 1.

As illustrated in FIG. 1, the fishing reel according to this embodiment comprises a reel body 1 having left and right side plates 1A and 1B in which left and right frames 2a and 2b are covered with left and right covers 3a and 3b, respectively. In the reel body 1, a reel leg located between the left and right side plates and attached to a fishing rod 100 is integrally formed. A spool shaft is rotatably supported between the left and right frames 2a and 2b by way of a bearing, and a spool 3, around which a fishing line is wound, is integrally fixed to the spool shaft.

In this embodiment, a handle 5 that rotationally drives the spool 3 is installed on the left side plate 1A side, and a known power transmission mechanism that transmits a rotational driving force of the handle 5 to the spool shaft is disposed in a space between the left frame 2b and the left cover 3b. In addition, a known clutch mechanism that switches the spool shaft between the power transmitting state and the power shielding state is disposed on one of the side plates, and the clutch mechanism switches from the clutch ON state (power transmitting state) to the OFF state (power shielding state) by pushing down a clutch lever 8 disposed between the left and right side plates on the back side of the spool 3. Here, the return from the clutch OFF state to the clutch ON state can be performed by rotating the handle 5 by a known automatic return mechanism.

A level wind device 10 is disposed between the left and right side plates 1A and 1B and in front of the spool 3. The level wind device 10 comprises a fishing line guide 20 through which the fishing line wound around the spool 3 is inserted, and the fishing line guide 20 is reciprocated between the left and right side plates of the reel body 1 to evenly wind the fishing line around the spool 3. Specifically, the fishing line guide 20 is engaged with a worm shaft (screw shaft) 11 rotationally driven via the power transmission mechanism, and when the worm shaft 11 is rotationally driven along with the rotational operation of the handle 5, the fishing line guide 20 engaged with the worm shaft 11 is reciprocally driven.

Note that, the worm shaft 11 is accommodated in a tubular body (cylindrical body) 12 turnably held between the left and right side plates, and a long hole 12a extending in the axial direction is formed in an outer surface of the tubular body 12. A spiral groove 11a is formed in the surface of the worm shaft 11, and the spiral groove is exposed through the long hole 12a. When an engagement pin 29 of the fishing line guide 20 is engaged with the spiral groove 11a, the fishing line guide 20 is reciprocally driven with the rotation of the worm shaft 11.

Hereinafter, the configuration of the above-described fishing line guide 20 will be described. The fishing line guide 20 comprises a pair of rollers 22 each provided with a through hole 22a extending in the axial direction (rotation axis direction of the roller), a pair of roller fixing shafts 24 inserted through the through holes 22a of the respective rollers 22 to rotatably support the rollers, and a base portion 28 supporting the pair of roller fixing shafts 24 and engaging with the worm shaft 11 supported between the left and right side plates.

The base portion 28 of this embodiment is formed in a substantially cylindrical shape, and has a through hole 28a through which the tubular body 12 penetrates in the left-right direction. The through hole 28a and the tubular body 12 inserted into the through hole 28a are engaged by an engagement relationship having a non-circular cross section, and the base portion 28 is in a state of being prevented from rotating with respect to the tubular body 12. In addition, a holding hole 28b for holding the engaging pin 29 screwed into the spiral groove 11a of the exposed worm shaft 11 is formed in the base portion 28. A female screw portion 28c is formed in an inner circumferential surface of the holding hole 28b, and a male screw portion 29a of a fixing member 29A holding the engagement pin 29 is screwed and fixed thereto, so that the spiral groove 11a of the worm shaft 11 and the engagement pin 29 are engaged.

The pair of roller fixing shafts 24 are formed so as to extend in the up-down direction at constant intervals along the direction in which the worm shaft 11 extends, and when the roller fixing shafts 24 are inserted into the through holes 22a of the rollers 22 respectively, a gap S through which the fishing line can be inserted is formed between the pair of rollers. In other words, since the rollers 22 are only rotatably held by the roller fixing shafts 24 and their outer circumferential surfaces are exposed, the frictional resistance to act on the fishing line coming into contact with their outer circumferential surfaces is reduced, thus enabling the rollers to smoothly rotate. Note that, each roller 22 is preferably formed of a material having low frictional resistance, e.g. a metal material such as aluminum or titanium, or formed by metal plating a resin material.

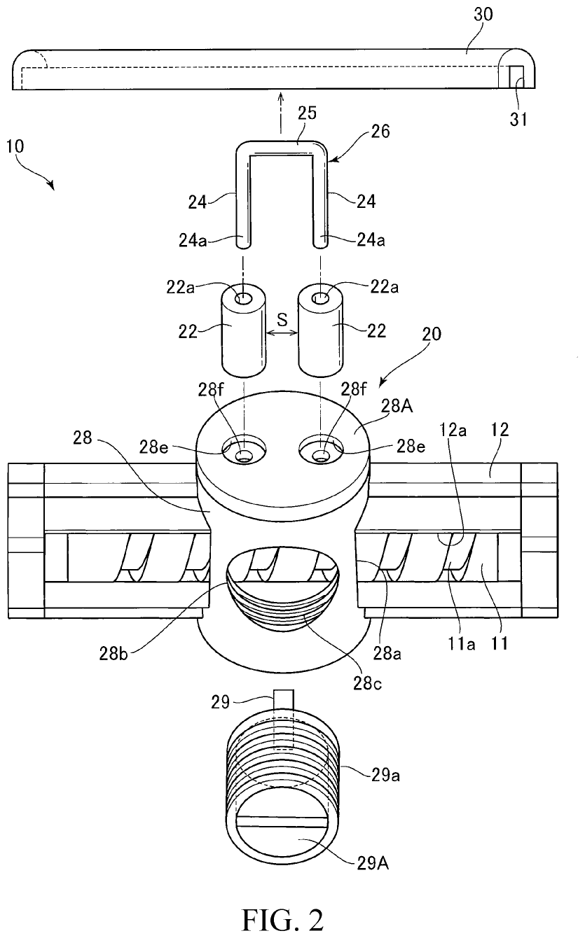

In addition, the pair of roller fixing shafts 24 respectively holding the rollers 22 preferably have an integrated structure such as a frame structure as illustrated in FIG. 2. In this embodiment, the pair of roller fixing shafts 24 have such a frame structure that their upper ends are integrally connected by a connecting portion 25 (substantially U-shaped frame body 26), thus improving handleability, assemblability, and strength. Here, the frame body 26 can be integrally formed of a hard resin, for example, or can be formed by bending a metal material.

The pair of roller fixing shafts 24 are supported on the base portion 28. In this case, it is preferable that a metal plate 28A is installed on a surface of the base portion 28 and ends 24a of the pair of roller fixing shafts 24 are supported by the plate 28A. Circular recesses 28e in which lower ends of the rollers 22 are located are formed in a surface of the plate 28A, and through holes 28f are formed at the center of the recesses 28e respectively. In addition, fitting holes 28g are formed in the surface of the base portion 28 at positions corresponding to the through holes 28f of the plate 28A, and thus when the plate 28A is installed on the surface of the base portion 28, the roller fixing shafts 24 of the frame body 26 are supported by the base portion 28 while holding the rollers 22. In this case, a constant gap G is formed in each circular recess 28e so that the recess can be kept in non-contact with the roller 22 held by the roller fixing shaft 24.

The frame body 26 is, on its upper side, engaged with a guide shaft 30 disposed between the left and right side plates 1A and 1B. A recessed groove 31 is formed in the guide shaft 30 of this embodiment along the axial direction, and the frame body 26 can stably reciprocate in the left-right direction by engaging the connecting portion 25 of the frame body 26 with the recessed groove 31. Note that, an upper surface of the connecting portion 25 is preferably slightly separated from the bottom of the recessed groove 31, so that the frame body 26 can smoothly slide in the left-right direction.

According to the level wind device 10 having the above configuration, when the clutch is turned off and the fishing line is released, the fishing line is inserted into the gap S between the pair of rollers 22 and does not receive a large resistance from the surfaces of the rollers 22. To put it another way, the rollers 22 are held by the roller fixing shafts 24 to be rotatable, and unlike the known technique described above, no resistance due to contact of a roller cover or the like for fixing the roller is generated, so that the pair of rollers 22 can smoothly rotate even when the fishing line comes into contact with rollers. As a result, the flying distance does not decrease at the time of casting the fishing line, and the falling speed does not decrease at the time of the fishing line releasing operation.

When the clutch is returned to ON and the handle 5 is wound up, the fishing line guide 20 is reciprocally driven in the left-right direction by the engagement pin 29 engaged with the spiral groove 11a of the worm shaft 11 driven to rotate, so that the fishing line is evenly wound around the spool 3. Since a large resistance does not act on the fishing line even in this state, the winding operation can be performed lightly.

Since the above-described fishing line guide 20 is configured by three components of the pair of rollers 22, the frame body 26, and the base portion 28 (the plate 28 A), the number of components can be reduced, and because of their simple configuration, it is possible to improve the assemblability and the exchangeability of the components (improvement in maintainability) as the level wind device. In addition, since the structure is simplified, it is possible to reduce cost, reduce the influence of tolerance, and make rattling less likely to occur.

Further, in the configuration described above, since the number of components is reduced, it is possible to reduce weight as the level wind device. In this case, in this embodiment, since the frame body 26 is fixed by disposing the metal plate 28A on the base portion 28, it is possible to secure the fixing strength as a whole. Thus, the other components can be formed of a lightweight material such as resin, and the weight can be more efficiently reduced.

The embodiment according to the present invention has been described above, but the present invention is not limited to the above embodiment and may be modified in various ways.

The present invention has features in the mounting structure of the rollers 22 of the fishing line guide 20 of the level wind device 10, and other configurations, for example, the size and shape of the reel body, the engagement member to be engaged with the worm shaft 11, and the like are not particularly limited. In addition, any fishing line guide 20 will do as long as it comprises the roller fixing shafts 24 that hold the pair of rollers 22, and is not limited to the linear frame structure (frame body 26) as illustrated in the drawing and can be appropriately deformed.

What is claimed is:

1. A fishing reel comprising a level wind device that uniformly winds a fishing line around a spool rotatably supported between left and right side plates of a reel body,
wherein the level wind device comprises a fishing line guide that comprises: a pair of rollers each provided with a through hole extending in an axial direction; a pair of roller fixing shafts inserted into the through holes of the pair of rollers and rotatably supporting the rollers; and a base portion supporting the pair of roller fixing shafts and engaging with a worm shaft supported between the left and right side plates, and
a fishing line is inserted into between the pair of rollers.

2. The fishing reel according to claim 1, wherein the pair of roller fixing shafts has such a frame structure that the roller fixing shafts are integrated by a connecting portion.

3. The fishing reel according to claim 2, wherein the connecting portion is engaged with a guide shaft disposed between the left and right side plates.

4. The fishing reel according to claim 1, wherein a metal plate is installed on the base portion, and each end of the pair of roller fixing shafts is held on the plate.
